(19) United States
(12) Patent Application Publication
(10) Pub. No.: US 2008/0278609 A1
(43) Pub. Date: Nov. 13, 2008

(54) IMAGING APPARATUS, DEFECTIVE PIXEL CORRECTING APPARATUS, PROCESSING METHOD IN THE APPARATUSES, AND PROGRAM

(75) Inventor: Hiroki Otsuki, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/114,314

(22) Filed: May 2, 2008

(30) Foreign Application Priority Data
May 7, 2007 (JP) 2007-122127

(51) Int. Cl. H04N 9/64

(52) U.S. Cl. 348/247; 348/E09.037

(57) ABSTRACT

An imaging apparatus includes a defective pixel storing unit to store positional information of a defective pixel among pixels in an imaging device and pixel defect information indicating whether a defective pixel group including defective pixels includes the defective pixel related to the positional information; an image input unit to input an image; a defective pixel determining unit to determine whether each pixel in the input image is a defective pixel; a pixel sharing defect determining unit to determine whether the defective pixel is included in the defective pixel group; a pixel type determining unit to determine the type of each pixel in the input image; an interpolated pixel selecting unit to select surrounding pixels of the defective pixel; an interpolation value calculating unit to calculate an interpolation value of the defective pixel; and an interpolation value substituting unit to substitute the value of the defective pixel with the interpolation value.

### CROSS REFERENCES TO RELATED APPLICATIONS

The present invention contains subject matter related to Japanese Patent Application JP 2007-122127 filed in the Japanese Patent Office on May 7, 2007, the entire contents of which are incorporated herein by reference.

### BACKGROUND OF THE INVENTION

1. Field of the Invention

The present invention relates to an imaging apparatus. Particularly, the present invention relates to an imaging apparatus to correct a defective pixel included in an image captured by using an imaging device, a defective pixel correcting apparatus, a processing method in those apparatuses, and a program allowing a computer to execute the method.

2. Description of the Related Art

In recent years, imaging apparatuses to capture images of subjects, such as digital video cameras and digital still cameras, have been widely used. Also, the imaging apparatuses have been miniaturized and the quality of images in the imaging apparatuses has become higher. Typically, pixel defects including white defects and black defects occur in a solid-state imaging device mounted in those imaging apparatuses. The white defect is a pixel defect in which a certain amount of charge is superimposed on an electric signal according to the amount of incident light, whereas the black defect is a pixel defect in which a signal level decreases at a certain rate, or a pixel defect in which a low-level signal is output with no response to incident light.

Those defective pixels appear as white or black spots on a captured image and cause degradation of image quality. Thus, it is important to minimize the effect of the defective pixels in order to enhance the performance of the imaging apparatus. However, it is typically difficult to completely eliminate the defective pixels in a solid-state imaging device. Under these circumstances, there have been suggested many defective pixel correcting methods for detecting and correcting defective pixels in a signal processor by using image signals output from the solid-state imaging device.

For example, the following defective pixel correcting method has been widely used. That is, a defective pixel is detected during adjustment or at power-on in a site of manufacturing, and positional information of the detected defective pixel is held in a storage unit, such as a register or a memory. During imaging, an interpolation value is calculated by using a plurality of pixel signals adjacent to the pixel to be corrected based on the held positional information, and the value of the defective pixel is substituted with the interpolation value.

Also, the following defective pixel correcting method has been suggested (for example, see Patent Document 1: Japanese Unexamined Patent Application Publication No. 06-153087 (FIG. 1)). That is, the correlations between a pixel in a color space corresponding to the position of a defective pixel in an arbitrary color space and respective pixels around the pixel are calculated. Then, the defective pixel is corrected by using the pixel in the color space corresponding to the position of the pixel having the strongest correlation among the calculated correlations.

### SUMMARY OF THE INVENTION

According to the above-described related art, a defective pixel can be corrected by a relatively simple configuration.

On the other hand, with the recent miniaturization and higher image quality of imaging apparatuses, many techniques about increasing pixels and miniaturization in imaging devices have been developed.

For example, a technique about a pixel sharing structure, in which part of a transistor group constituting pixels of an imaging device is shared by a plurality of adjacent pixels, has been realized. With this technique, pixels can be miniaturized and an imaging apparatus can also be miniaturized.

However, in an imaging device having the pixel sharing structure, if an amplifier transistor serving as an element of the sharing structure breaks down, all the adjacent pixels sharing the broken transistor may become defective pixels. Therefore, when a defective pixel included in an image captured by using an imaging device having the pixel sharing structure is to be corrected, it is important to appropriately correct an adjacent pixel defect resulting from the pixel sharing structure. In a structure other than the pixel sharing structure, it is possible that a defect occurs in each pixel included in a pixel group constituted by a plurality of pixels due to a structural problem.

Accordingly, the present invention is directed to appropriately correcting each defective pixel included in a group of defective pixels.

According to an embodiment of the present invention, there is provided an imaging apparatus including a defective pixel storing unit configured to store positional information of a defective pixel among pixels included in an imaging device and pixel defect information indicating whether a defective pixel group including a plurality of defective pixels includes the defective pixel related to the positional information, the positional information being associated with the pixel defect information; an image input unit configured to input an image captured by the imaging device; a defective pixel determining unit configured to determine whether each pixel in the input image is a defective pixel based on the positional information stored in the defective pixel storing unit; a pixel sharing defect determining unit configured to determine whether the pixel determined to be a defective pixel is included in the defective pixel group based on the pixel defect information stored in the defective pixel storing unit; a pixel type determining unit configured to determine the type of each pixel in the input image; an interpolated pixel selecting unit configured to select surrounding pixels of the pixel determined to be a defective pixel based on the type of the defective pixel and a determination result indicating whether the defective pixel is included in the defective pixel group; an interpolation value calculating unit configured to calculate an interpolation value of the pixel determined to be a defective pixel based on values of the selected surrounding pixels; and an interpolation value substituting unit configured to substitute the value of the pixel determined to be a defective pixel with the calculated interpolation value. Also, a processing method in the imaging apparatus and a program allowing a computer to execute the method are provided. Accordingly, whether each pixel in an image captured by the imaging device is a defective pixel is determined, whether the pixel determined to be a defective pixel is included in a defective pixel group is determined, and the type of each pixel in the input image is determined. Based on the type of the defective pixel and whether the defective pixel is included in the defective pixel group, surrounding pixels of the defective pixel are selected. Then, an interpolation value of the defective pixel is calculated based on the values of the selected surrounding pixels, and the value of the defective pixel is substituted with the calculated interpolation value.

The defective pixel storing unit may store the positional information and the pixel defect information of one of the defective pixels included in the defective pixel group. The imaging apparatus may further include a positional information calculating unit configured to calculate positional information of the other defective pixels in the defective pixel group including the defective pixel based on the positional information of the one of the defective pixels included in the defective pixel group stored in the defective pixel storing unit. The defective pixel determining unit may determine whether each pixel in the input image is a defective pixel based on the positional information stored in the defective pixel storing unit and the calculated positional information. The pixel sharing defect determining unit may determine whether the pixel determined to be a defective pixel is included in the defective pixel group based on the calculated positional information. Accordingly, the position information of the other defective pixels in the defective pixel group is calculated based on the positional information of one of the defective pixels included in the defective pixel group, whether each pixel in the input image is a defective pixel is determined based on the positional information in the defective pixel storing unit and the calculated positional information, and whether the defective pixel is included in the defective pixel group is determined based on the calculated positional information.

The defective pixel group may be a pixel group including a plurality of adjacent defective pixels. Accordingly, the plurality of adjacent defective pixels included in the defective pixel group are corrected. The imagine device may include a pixel group having a pixel sharing structure and the defective pixel group may be a pixel group in which a plurality of pixels included in the pixel group having the pixel sharing structure have a defect. Accordingly, the defective pixels included in the pixel group having the pixel sharing structure are corrected. In this case, a color filter having a diagonal pixel array is attached to a light receiving unit of the imaging device, and the pixel group having the pixel sharing structure includes four adjacent pixels in the diagonal pixel array. Accordingly, in an image captured by the imaging device provided with the color filter having the diagonal pixel array, defective pixels included in the defective pixel group including four adjacent pixels in the diagonal pixel array are corrected.

The imaging apparatus may further include a consecutive defect determining unit configured to determine whether an adjacent pixel of the pixel determined to be a defective pixel is a defective pixel based on the positional information of the pixel determined to be a defective pixel. The interpolated pixel selecting unit may select surrounding pixels of the pixel determined to be a defective pixel based on the type of the defective pixel, a determination result indicating whether the defective pixel is included in the defective pixel group, and a determination result indicating whether the adjacent pixel of the pixel determined to be a defective pixel is a defective pixel. Accordingly, whether a pixel adjacent to the defective pixel is a defective pixel is determined based on the positional information of the defective pixel, and surrounding pixels of the defective pixel are selected based on the type of the defective pixel, whether the defective pixel is included in the defective pixel group, and whether a pixel adjacent to the defective pixel is a defective pixel.

According to another embodiment of the present invention, there is provided a defective pixel correcting apparatus including a defective pixel storing unit configured to store positional information of a defective pixel among pixels included in an imaging device and pixel defect information indicating whether a defective pixel group including a plurality of defective pixels includes the defective pixel related to the positional information, the positional information being associated with the pixel defect information; an image input unit configured to input an image captured by the imaging device; a defective pixel determining unit configured to determine whether each pixel in the input image is a defective pixel based on the positional information stored in the defective pixel storing unit; a pixel sharing defect determining unit configured to determine whether the pixel determined to be a defective pixel is included in the defective pixel group based on the pixel defect information stored in the defective pixel storing unit; a pixel type determining unit configured to determine the type of each pixel in the input image; an interpolated pixel selecting unit configured to select surrounding pixels of the pixel determined to be a defective pixel based on the type of the defective pixel and a determination result indicating whether the defective pixel is included in the defective pixel group; an interpolation value calculating unit configured to calculate an interpolation value of the pixel determined to be a defective pixel based on values of the selected surrounding pixels; and an interpolation value substituting unit configured to substitute the value of the pixel determined to be a defective pixel with the calculated interpolation value. Also, a processing method in the defective pixel correcting apparatus and a program allowing a computer to execute the method are provided. Accordingly, whether each pixel in an image captured by the imaging device is a defective pixel is determined, whether the pixel determined to be a defective pixel is included in a defective pixel group is determined, and the type of each pixel in the input image is determined. Based on the type of the defective pixel and whether the defective pixel is included in the defective pixel group, surrounding pixels of the defective pixel are selected. Then, an interpolation value of the defective pixel is calculated based on the values of the selected surrounding pixels, and the value of the defective pixel is substituted with the calculated interpolation value.

According to an embodiment of the present invention, each of defective pixels included in a defective pixel group can be appropriately corrected.

### BRIEF DESCRIPTION OF THE DRAWINGS

FIG. 1 is a block diagram illustrating an example of a functional configuration of an imaging apparatus;

FIG. 2 is a block diagram illustrating an example of a functional configuration of a camera signal processor;

FIG. 3 illustrates an example of a pixel array in a case of using a color filter having a so-called diagonal pixel array;

FIGS. 4A to 4C illustrate an example of a pixel sharing structure of an imaging device in the color filter having the diagonal pixel array;

FIG. 5 is a block diagram illustrating an example of a functional configuration of a defective pixel corrector;

FIG. 6 schematically illustrates defective pixel address information stored in a defective pixel address storing unit;

FIG. 7 is a block diagram illustrating an example of a functional configuration of a defective pixel determining unit;

FIG. 8 is a block diagram illustrating an example of a functional configuration of a candidate interpolated pixel selector;

FIG. 9 schematically illustrates an example of a pixel array in a case where a defective pixel does not exist in adjacent pixels of a defective R pixel;

FIG. 10 schematically illustrates an example of a pixel array in a case where a pixel group including a defective R pixel has a pixel sharing defect;

FIG. 11 schematically illustrates an example of a pixel array in a case where a defective pixel exists in adjacent pixels of a defective G1 pixel in the vertical direction;

FIG. 12 schematically illustrates an example of a pixel array in a case where a pixel group including a G1 pixel has a pixel sharing defect;

FIG. 13 schematically illustrates an example of a pixel array in a case where a pixel group including a G1 pixel has a pixel sharing defect and a defective pixel exists in adjacent pixels of the G1 pixel in the horizontal direction;

FIG. 14 schematically illustrates an example of a pixel array in the same case as that in FIG. 13;

FIG. 15 schematically illustrates an example of a pixel array in the same case as that in FIG. 13;

FIG. 16 schematically illustrates an example of a pixel array in a case where a defective pixel exists in adjacent pixels of a defective Gr pixel in diagonal directions;

FIG. 17 schematically illustrates an example of a pixel array in a case where a pixel group including a Gr pixel has a pixel sharing defect;

FIG. 18 schematically illustrates an example of a pixel array in the same case as that in FIG. 17;

FIG. 19 schematically illustrates an example of a pixel array in the same case as that in FIG. 17;

FIG. 20 is a flowchart illustrating a procedure of a process of correcting a defective pixel performed by the imaging apparatus; and

FIG. 21 is a flowchart illustrating the procedure of the process of correcting a defective pixel performed by the imaging apparatus.

### DESCRIPTION OF THE PREFERRED EMBODIMENTS

Hereinafter, an embodiment of the present invention is described in detail with reference to the drawings.

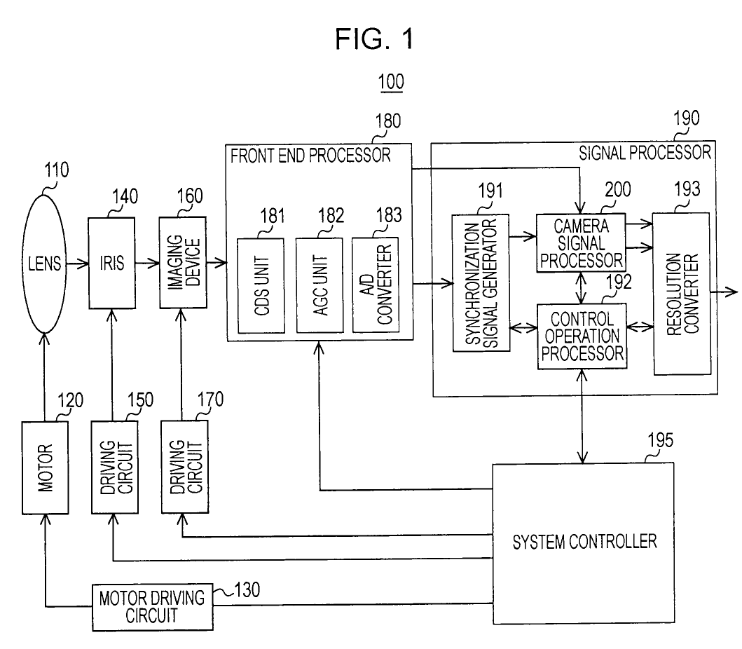

FIG. 1 is a block diagram illustrating an example of a functional configuration of an imaging apparatus 100 according to the embodiment of the present invention. The imaging apparatus 100 includes a lens 110, a motor 120, a motor driving circuit 130, an iris 140, a driving circuit 150, an imaging device 160, a driving circuit 170, a front end (F/E) processor 180, a signal processor 190, and a system controller 195.

The lens 110 collects incident light from a light source and a reflected light from a subject. The motor 120 rotates in accordance with a driving signal output from the motor driving circuit 130 so as to move the lens 110 and to adjust a focal length and a focal position of a subject. The motor driving circuit 130 generates a driving signal to rotate the motor 120 based on control by the system controller 195 and outputs the driving signal to the motor 120. The motor driving circuit 130 determines a focal length (i.e., a zoom position) in accordance with a scaling operation by a user.

The iris 140 adjusts an aperture according to the illumination of a subject based on a driving signal output from the driving circuit 150 and determines the amount of light passed through the lens 110 (i.e., exposure). The driving circuit 150 generates a driving signal to adjust the iris 140 based on control by the system controller 195 and outputs the driving signal to the iris 140.

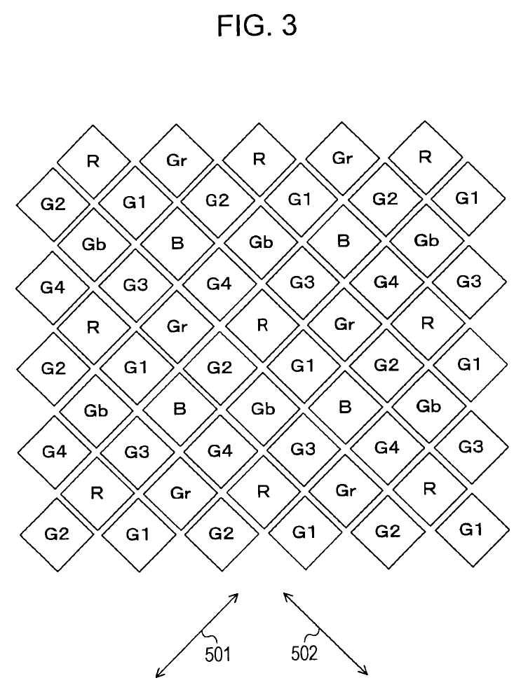

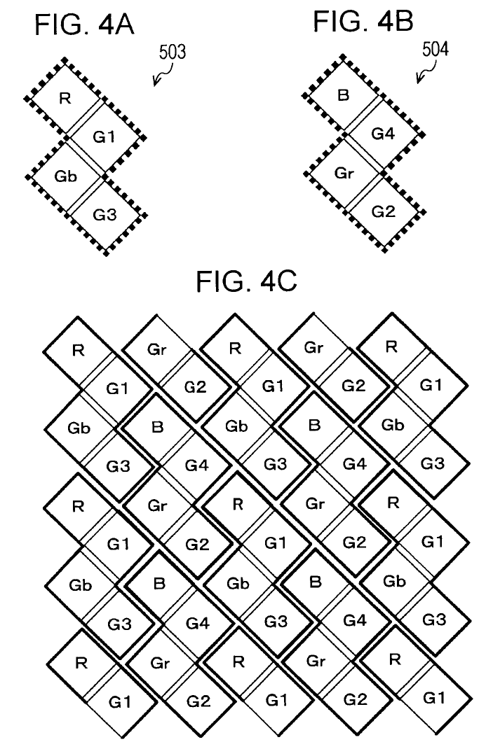

The imaging device 160 performs photoelectric conversion on an optical signal passed through the iris 140 based on a driving signal output from the driving circuit 170 and outputs a charge signal generated through the photoelectric conversion to the front end processor 180. The imaging device 160 includes a device, such as a CCD (charge coupled device) or a CMOS (complementary metal-oxide semiconductor). In the embodiment of the present invention, a single imaging device is used as the imaging device 160, and a color filter having a so-called diagonal pixel array is used as a color filter attached to the light receiving unit thereof. The imaging device 160 has a pixel sharing structure in which part of a transistor group constituting pixels is shared by four adjacent pixels. The color filter having the diagonal pixel array and the pixel sharing structure are described below in detail with reference to FIGS. 3 and 4A to 4C.

The driving circuit 170 generates a driving signal, which is used by the imaging device 160 to perform photoelectric conversion, based on control by the system controller 195, and outputs the driving signal to the imaging device 160.

The front end processor 180 performs processing including denoising and amplification on an analog charge signal output from the imaging device 160 and converts the charge signal to a digital signal. The front end processor 180 includes a CDS (correlated double sampling) unit 181, an AGC (automatic gain control) unit 182, and an A/D converter 183. The CDS unit 181 performs sampling on an input signal and then holds the sampled signal at a certain value. The AGC unit 182 performs amplification on an input signal. The A/D converter 183 converts an input analog signal to a digital signal. In the embodiment of the present invention, the front end processor 180 and the imaging device 160 are separate from each other. Alternatively, the front end processor 180 and the imaging device 160 may be placed on the same substrate. For example, a so-called column A/D image sensor or the like can be used.

The signal processor 190 performs a camera control process, such as AWB (auto white balance), AE (automatic exposure), and AF (auto focus), on an imaging signal of a subject converted to a digital signal by the front end processor 180 based on a control signal from the system controller 195, and generates a video signal (a luminance signal and a color-difference signal) of the subject. The signal processor 190 includes a synchronization signal generator 191, a camera signal processor 200, a control operation processor 192, and a resolution converter 193. For example, the signal processor 190 is realized by an integrated circuit (hardware). Alternatively, the whole or part of the configuration of the signal processor 190 can be realized in a software manner by using a computer or the like.

The synchronization signal generator 191 generates synchronization signals in horizontal and vertical directions and various timing signals and outputs the generated synchronization signals to the camera signal processor 200.

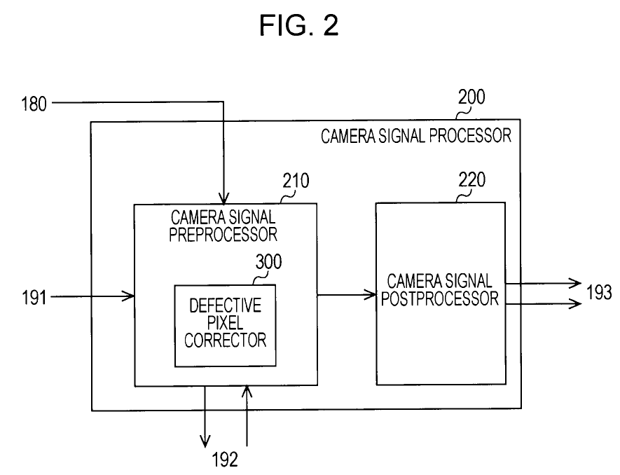

The camera signal processor 200 performs a control process based on a control signal from the system controller 195 and generates a video signal of a subject. The camera signal processor 200 is described below in detail with reference to FIG. 2.

The control operation processor 192 performs various operations to control a video signal of a subject based on a control signal from the system controller 195.

The resolution converter 193 performs resolution conversion and distortion correction on a video signal of a subject output from the camera signal processor 200.

The system controller 195 controls each unit of the imaging apparatus 100. For example, the system controller 195 is realized by a CPU (central processing unit).

FIG. 2 is a block diagram illustrating an example of a functional configuration of the camera signal processor 200. The camera signal processor 200 includes a camera signal preprocessor 210 and a camera signal postprocessor 220.

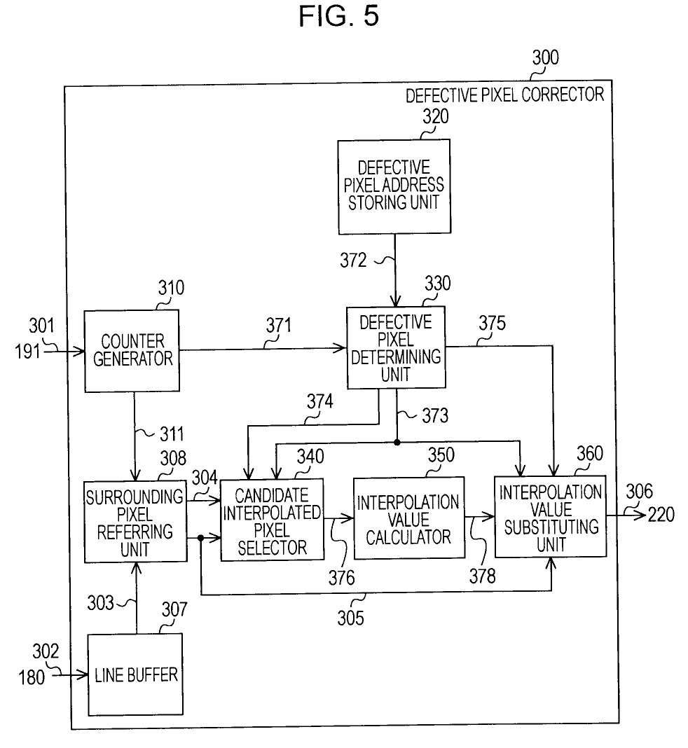

The camera signal preprocessor 210 performs various processes of correcting defective pixels, shading, and noise resulting from the lens 110, the iris 140, and the imaging device 160 on an imaging signal of a subject output from the front end processor 180 by using various synchronization signals from the synchronization signal generator 191, and includes a defective pixel corrector 300. The defective pixel corrector 300 corrects a defective pixel resulting from a crystal defect or the like of the imaging device 160. The defective pixel corrector 300 is described below in detail with reference to FIG. 5.

When an input signal from the imaging device 160 is a complementary-color signal constituted by C (cyan), M (magenta), Y (yellow), and G (green), the camera signal preprocessor 210 performs primary-color separation on the input signal so as to separate it to primary-color signals of R (red), G (green), and B (blue). Accordingly, the RGB signals are input to the camera signal postprocessor 220 and the control operation processor 192.

The camera signal postprocessor 220 generates a video signal (a luminance signal and a color-difference signal) from an imaging signal of a subject processed by the camera signal preprocessor 210. The video signal generated by the camera signal postprocessor 220 is supplied to the resolution converter 193.

FIG. 3 illustrates an example of a pixel array in a case of using a color filter of a so-called diagonal pixel array as the color filter of the imaging device 160 (see Japanese Unexamined Patent Application Publication No. 2005-107037). In the color filter having the diagonal pixel array, the ratio of G, R, and B is 6:1:1 (on the other hand, the ratio of G, R, and B is 2:1:1 in the Bayer array), and the pixel array is rotated by 45 degrees. In this pixel array, G pixels include six types of same-color pixels G1 to G4 and Gr and Gb. The Gr pixel is a G pixel existing in a row including R pixels, and the Gb pixel is a G pixel existing in a row including B pixels. The G1 to G4 pixels are G pixels existing in rows between the row including the R pixels and the row including the B pixels, and each number is an identification number. FIGS. 3 and 4A to 4C and FIGS. 9 to 19 illustrate part of the diagonal pixel array of the color filter. Note that, in each of these figures, the direction indicated by an arrow 501 (see FIG. 3), a 45° clockwise turn of the vertical axis, is called an “ascending direction”, and the direction indicated by an arrow 502, a 45° counterclockwise turn of the vertical axis, is called a “descending direction”.

As illustrated in FIG. 3, the R pixels are not adjacent to each other in the horizontal and vertical directions, and are arranged every other pixel. This is the same for the B pixels. Among the G pixels, the G1 to G4 pixels having the same color are consecutively arranged in the horizontal and vertical directions. Regarding the G1 and G4 pixels, the adjacent pixels in the ascending direction are same-color pixels, whereas the adjacent pixels in the descending direction are not same-color pixels. That is, the same-color pixels are arranged every other pixel. Regarding the G2 and G3 pixels, the adjacent pixels in the descending direction are same-color pixels, whereas the adjacent pixels in the ascending direction are not same-color pixels. That is, the same-color pixels are arranged every other pixel. Regarding the Gr and Gb pixels, the adjacent pixels in the horizontal and vertical directions are not same-color pixels, but the adjacent pixels in the ascending and descending directions are same-color pixels. Also, the same-color pixels are arranged every other pixel in the horizontal and vertical directions and in the ascending and descending directions.

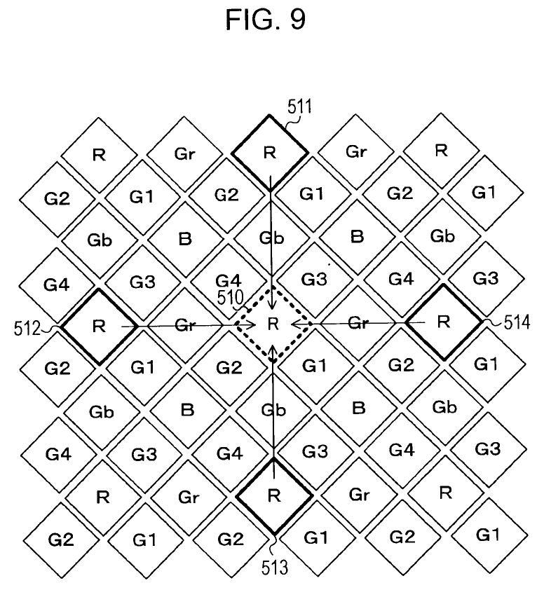

As described above, each pixel has surrounding pixels of the same color. Thus, if a defective pixel exists in the color filter having the diagonal pixel array, the defective pixel is corrected by using same-color pixels near the defective pixel in the embodiment of the present invention. The surrounding pixels used for correcting the defective pixel are described below in detail with reference to FIGS. 9 to 19.

FIGS. 4A to 4C illustrate an example of the pixel sharing structure of the imaging device, in which part of a transistor group constituting pixels of the imaging device is shared by four adjacent pixels in the color filter having the diagonal pixel array. FIGS. 4A and 4B schematically illustrate pixel groups 503 and 504 having a four-pixel sharing structure, respectively. FIG. 4C schematically illustrates part of a pixel array in a case of using an imaging device having the four-pixel sharing structure.

In the pixel group 503 illustrated in FIG. 4A, four pixels in a zigzag pattern: an R pixel at the head, a G1 pixel, a Gb pixel, and a G3 pixel, share part of a transistor group serving as a shared element. In the pixel group 504 illustrated in FIG. 4B, four pixels in a zigzag pattern: a B pixel at the head, a G4 pixel, a Gr pixel, and a G2 pixel, share part of a transistor group serving as a shared element. FIG. 4C illustrates part of the pixel array including the pixel groups 503 and 504, in which each pixel group is defined by a bold line. In the pixel array illustrated in FIG. 4C, a lower portion of the pixel group 503 and an upper portion of the pixel group 504 are partially omitted.

By adopting the pixel sharing structure in the imaging device, the pixels of the imaging device can be miniaturized. In recent years, using the pixel sharing structure has been becoming a must technique in order to miniaturize the imaging apparatus.

However, in the imaging device having the pixel sharing structure, if an amplifier transistor serving as a shared element breaks down, all of adjacent pixels sharing the broken transistor may become defective pixels. In the embodiment of the present invention, a defect of adjacent pixels resulting from the pixel sharing structure is called a “pixel sharing defect”. On the other hand, a pixel defect in a case where one of two adjacent pixels in the horizontal direction has a defect is called a “consecutive adjacent pixel defect”, and a pixel defect in a case where no defect exists in adjacent pixels is called a “single pixel defect”.

FIG. 5 is a block diagram illustrating an example of a functional configuration of the defective pixel corrector 300. The defective pixel corrector 300 includes a line buffer 307, a surrounding pixel referring unit 308, a counter generator 308, a defective pixel address storing unit 320, a defective pixel determining unit 330, a candidate interpolated pixel selector 340, an interpolation value calculator 350, and an interpolation value substituting unit 360.

The line buffer 307 is a line buffer for a plurality of lines and holds a plurality of lines of pixels input as an input signal 302 in units of lines.

The surrounding pixel referring unit 308 sequentially reads a target pixel to be corrected and surrounding pixels of the target pixel from among the lines of pixels held in the line buffer 307. Then, the surrounding pixel referring unit 308 outputs the read target pixel as an input signal 305 to the candidate interpolated pixel selector 340 and the interpolation value substituting unit 360, and also outputs the surrounding pixels as an input signal 304 to the candidate interpolated pixel selector 340.

The counter generator 310 generates counter values in horizontal and vertical directions based on synchronization signals (horizontal and vertical synchronization signals) 301 input from the synchronization signal generator 191. Each of the generated counter values indicates coordinates (address) on the plane of a captured image, in which an upper-left point is an origin point and right and downward directions are positive directions. The counter value is composed of a horizontal counter value and a vertical counter value. The counter value is input as an input signal 371 to the defective pixel determining unit 330 and as an input signal 311 to the surrounding pixel referring unit 308. Accordingly, the input signal 371 input to the defective pixel determining unit 330 is synchronized with the input signal 304 input to the candidate interpolated pixel selector 340 and the input signal 305 input to the interpolation value substituting unit 360.

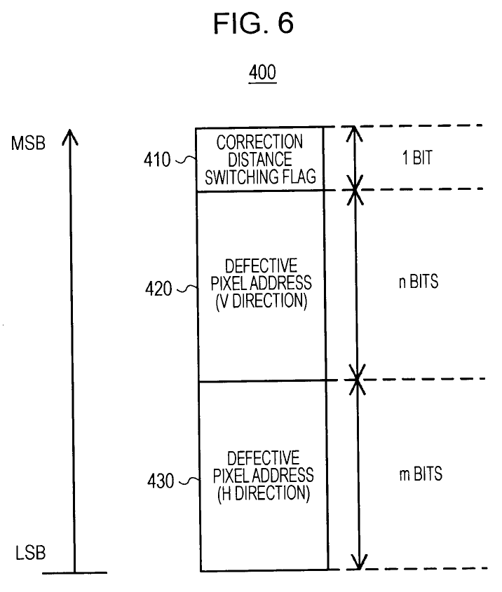

The defective pixel address storing unit 320 stores horizontal and vertical positional information (defective pixel address information) on the plane of a captured image of a defective pixel that is detected in a defective pixel detecting process of the imaging device 160 performed during a manufacturing process of the imaging device 160 or at power-on of the imaging apparatus 100. The defective pixel address storing unit 320 is constituted by a storage device, such as a register or a memory. The defective pixel address information is stored in advance in the defective pixel address storing unit 320 based on control by the system controller 195. The defective pixel address information is input as an input signal 372 to the defective pixel determining unit 330. The defective pixel address information is described below in detail with reference to FIG. 6.

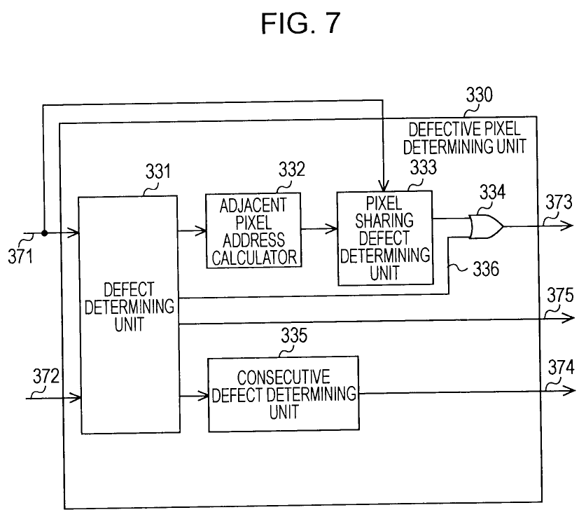

The defective pixel determining unit 330 compares the counter value input from the counter generator 310 with the defective pixel address information input from the defective pixel address storing unit 320. That is, if the counter value matches the defective pixel address information, the defective pixel determining unit 330 determines that the pixel corresponding to the counter value is a defective pixel, and outputs content of a defect flag about this pixel to a signal line 375. If the counter value matches the defective pixel address information and if a correction distance switching flag included in the defective pixel address information stores “1”, the defective pixel determining unit 330 outputs content of a pixel sharing defect flag, indicating that the pixel determined to be a defective pixel has a pixel sharing defect, to a signal line 373. Furthermore, the defective pixel determining unit 330 outputs content of the pixel sharing defect flag for the other defective pixels in the pixel group including the defective pixel having the pixel sharing defect to the signal line 373. If a comparison result between the counter value and the defective pixel address information indicates a consecutive defective pixel, the defective pixel determining unit 330 outputs content of a consecutive defect flag to a signal line 374. The defective pixel determining unit 330 is described below in detail with reference to FIG. 7.

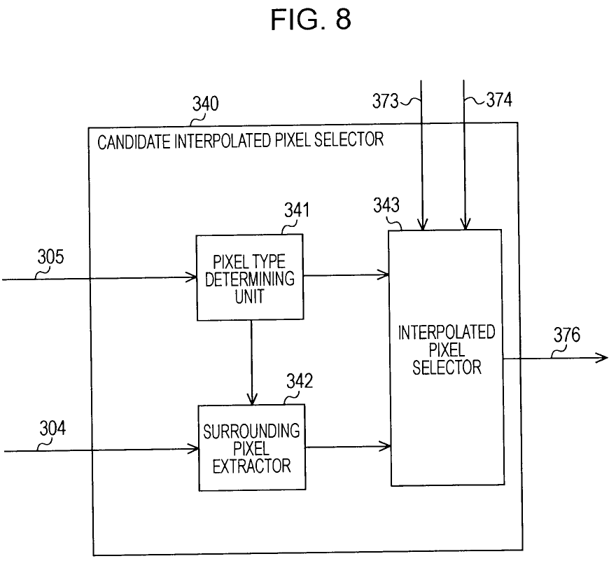

The candidate interpolated pixel selector 340 selects candidate pixels to be interpolated from among the surrounding pixels including the target pixel input from the surrounding pixel referring unit 308, and inputs the selected pixels to be interpolated as an input signal 376 to the interpolation value calculator 350. The candidate interpolated pixel selector 340 is described below in detail with reference to FIG. 8.

The interpolation value calculator 350 calculates an interpolation value by using the pixels to be interpolated input from the candidate interpolated pixel selector 340 and outputs the calculated interpolation value as an input signal 378 to the interpolation value substituting unit 360. Note that the number of pixels to be interpolated input from the candidate interpolated pixel selector 340 is two. The interpolation value is obtained by calculating an average value of the two pixels.

The interpolation value substituting unit 360 performs substitution of the interpolation value for a defective pixel based on the content of the pixel sharing defect flag or the defect flag output from the defective pixel determining unit 330 and the interpolation value of the defective pixel output from the interpolation value calculator 350. That is, if the input pixel is a defective pixel, the interpolation value substituting unit 360 substitutes the value of the defective pixel with the interpolation value and outputs a resulting pixel as an output signal 306. If the input pixel is not a defective pixel, the interpolation value substituting unit 360 outputs the input pixel, which is input as the input signal 305, as an output signal 306. In this way, by correcting the value of a defective pixel by substitution, degradation of quality of a captured image can be suppressed.

FIG. 6 schematically illustrates defective pixel address information 400 stored in the defective pixel address storing unit 320. The defective pixel address information 400 includes a correction distance switching flag 410, a defective pixel address (vertical direction) 420, and a defective pixel address (horizontal direction) 430.

The correction distance switching flag 410 indicates whether the pixel corresponding to the defective pixel address information 400 has a pixel sharing defect and is composed of one bit at the most significant bit (MSB). By using the correction distance switching flag 410, candidate interpolated pixels can be appropriately selected when an input pixel has a pixel sharing defect. For example, when the input pixel has a pixel sharing defect, “1” is stored in the correction distance switching flag 410. On the other hand, when the input pixel does not have a pixel sharing defect, “0” is stored in the correction distance switching flag 410. In the embodiment of the present invention, if a pixel sharing defect is detected during detection of defective pixels, the defective pixel address information of only the head pixel of the pixel group having the pixel sharing structure is stored in the defective pixel address storing unit 320. The head pixel of the pixel group having the pixel sharing structure is an R pixel in a pixel group including the R pixel as illustrated in FIG. 4A, or a B pixel in a pixel group including the B pixel as illustrated in FIG. 4B. Also, the addresses of the other defective pixels included in the pixel group having the pixel sharing structure can be calculated. For example, in the pixel group illustrated in FIG. 4A where the head pixel is an R pixel, when the positional information (address) of the R pixel is R(X,Y), the positional information (addresses) of the G1 pixel, Gb pixel, and G3 pixel included in this pixel group can be calculated as G1(X,Y+1), Gb(X,Y+2), and G3(X,Y+3), respectively. Also, the positional information of the pixel group including the B pixel as a head pixel can be calculated in the same manner.

As described above, the defective pixel address information of only the head pixel in the pixel group having the pixel sharing structure is stored in the defective pixel address storing unit 320, and the addresses of the other defective pixels are calculated based on the defective pixel address information of the head pixel. Accordingly, the pixel sharing defect can be corrected in not only the head pixel of the pixel group but also the other pixels in the pixel group without storing the address information of the other pixels of the pixel group in the defective pixel address storing unit 320. Furthermore, by using such a method, resources of the register or memory used as the defective pixel address storing unit 320 can be reduced, so that the size, weight, and cost of the imaging apparatus can be reduced.

The defective pixel address 420 is a value indicating positional information in the vertical direction (Y coordinate) of a defective pixel in a coordinate system, where an upper-left point is an origin point and right and downward directions are positive directions on the plane of a captured image. The defective pixel address 420 is defined by n bits, for example.

The defective pixel address 430 is a value indicating positional information in the horizontal direction (X coordinate) of a defective pixel in a coordinate system, where an upper-left point is an origin point and right and downward directions are positive directions on the plane of a captured image. The defective pixel address 430 is defined by m bits, for example.

FIG. 7 is a block diagram illustrating an example of a functional configuration of the defective pixel determining unit 330. The defective pixel determining unit 330 includes a defect determining unit 331, an adjacent pixel address calculator 332, a pixel sharing defect determining unit 333, an OR circuit 334, and a consecutive defect determining unit 335.

The defect determining unit 331 determines whether an input pixel is a defective pixel based on the counter value output from the counter generator 310 and the defective pixel address information input from the defective pixel address storing unit 320. More specifically, if the counter value from the counter generator 310 matches the defective pixel addresses 420 and 430 included in the defective pixel address information 400, the defect determining unit 331 determines that the pixel corresponding to the counter value is a defective pixel, outputs content of the defect flag indicating the defective pixel to the signal line 375, and also outputs the defective pixel address to the consecutive defect determining unit 335. If the counter value from the counter generator 310 matches the defective pixel addresses 420 and 430 and if the correction distance switching flag 410 included in the defective pixel address information 400 stores “1”, the defect determining unit 331 outputs the pixel sharing defect flag indicating that fact to the OR circuit 334 and also outputs the defective pixel addresses 420 and 430 included in the defective pixel address information 400 to the adjacent pixel address calculator 332.

The adjacent pixel address calculator 332 calculates the addresses of the defective pixels other than the head pixel included in the pixel group having the pixel sharing structure, as illustrated in FIGS. 4A and 4B, based on the defective pixel addresses 420 and 430 output from the defect determining unit 331, and holds the calculated addresses. Then, the adjacent pixel address calculator 332 outputs the addresses held therein to the pixel sharing defect determining unit 333.

The pixel sharing defect determining unit 333 determines whether an input pixel has a pixel sharing defect based on the addresses of the defective pixels other than the head pixel included in the pixel group having the pixel sharing structure held in the adjacent pixel address calculator 332 and on the counter value output from the counter generator 310. More specifically, if the defective pixel addresses held in the adjacent pixel address calculator 332 match the counter value output from the counter generator 310, the pixel sharing defect determining unit 333 determines that the pixel corresponding to the counter value has a pixel sharing defect, generates a pixel sharing defect flag, and outputs the pixel sharing defect flag to the OR circuit 334. For example, the pixel sharing defect determining unit 333 outputs “1” as the pixel sharing defect flag.

If the OR circuit 334 receives “1” as the pixel sharing defect flag from at least one of the pixel sharing defect determining unit 333 and the defect determining unit 331, the OR circuit 334 outputs the pixel sharing defect flag “1” to the signal line 373.

The consecutive defect determining unit 335 holds a defect flag output from the defect determining unit 331 and determines whether consecutive defective pixels exist in accordance with whether defect flags are consecutively input. If determining that consecutive defective pixels exist, the consecutive defect determining unit 335 generates a consecutive defect flag and outputs it to the signal line 374.

FIG. 8 is a block diagram illustrating an example of a functional configuration of the candidate interpolated pixel selector 340. The candidate interpolated pixel selector 340 includes a pixel type determining unit 341, a surrounding pixel extractor 342, and an interpolated pixel selector 343.

The pixel type determining unit 341 determines the type of a target pixel input as the input signal 305, and outputs the determined pixel type to the surrounding pixel extractor 342 and the interpolated pixel selector 343. Here, pixel types to be determined include an R pixel, a B pixel, G1 to G4 pixels, a Gb pixel, and a Gr pixel.

The surrounding pixel extractor 342 extracts a plurality of pixels from among surrounding pixels input as the input signal 304 based on the pixel type input from the pixel type determining unit 341 and outputs each of the extracted pixels to the interpolated pixel selector 343. For example, if the type of the target pixel is any of the G1 to G4 pixels, respective pixels physically adjacent to the target pixel in the horizontal and vertical directions and respective pixels physically next to the adjacent pixels in the horizontal and vertical directions are extracted. On the other hand, if the type of the target pixel is the Gr pixel or the Gb pixel, respective pixels physically adjacent to the target pixel in diagonal directions and respective pixels physically next to the pixels adjacent to the target pixel in the horizontal and vertical directions are extracted. Furthermore, if the type of the target pixel is the R pixel or the B pixel, respective pixels physically next to the pixels adjacent to the target pixel in the horizontal direction are extracted. These extraction examples are described below in detail with reference to FIGS. 9 to 19.

The interpolated pixel selector 343 selects interpolated pixels for the target pixel from among the plurality of pixels extracted by the surrounding pixel extractor 342 based on the type of the target pixel output from the pixel type determining unit 341 and the content of the pixel sharing defect flag and the consecutive defect flag output from the defective pixel determining unit 330.

For example, if the type of the target pixel is any of the G1 to G4 pixels and if the content of both the pixel sharing defect flag and the consecutive defect flag is “1”, two pixels physically next to the adjacent pixels of the target pixel in the horizontal direction are selected. On the other hand, if the content of both the pixel sharing defect flag and the consecutive defect flag is not “1”, two pixels physically adjacent to the target pixel in the horizontal direction are selected.

If the type of the target pixel is the Gr pixel or the Gb pixel and if the content of the pixel sharing defect flag is “1”, two pixels physically next to the adjacent pixels of the target pixel in the horizontal direction are selected. On the other hand, if the content of the pixel sharing defect flag is “0”, two pixels in a diagonal direction among four pixels physically adjacent to the target pixel in diagonal directions are selected.

Furthermore, if the type of the target pixel is the R pixel or the B pixel, two pixels physically next to the adjacent pixels of the target pixel in the horizontal direction are selected. In this way, if the target pixel is an R pixel or a B pixel, an effect of the pixel sharing defect need not be taken into consideration. Thus, interpolated pixels are selected regardless of the content of the pixel sharing defect flag and the consecutive defect flag.

Now, surrounding pixels that are extracted and selected by the candidate interpolated pixel selector 340 are described in detail with reference to the drawings. In the pixel arrays illustrated in FIGS. 9 to 19, a defective pixel is shown by a dotted line, and a pixel extracted as an interpolated pixel for the defective pixel is shown by a bold line. A pixel group having a pixel sharing defect is defined by a dotted line.

FIG. 9 schematically illustrates an example of a pixel array in a case where an R pixel is a defective pixel and the pixels adjacent to the R pixel have no defect.

In the pixel array illustrated in FIG. 9, an R pixel 510 is a single defect pixel, whereas R pixels 511 to 514, which are same-color pixels physically next to the adjoining pixels of the R pixel 510 in the horizontal and vertical directions, are not defective pixels. As in this case, when the R pixel 510 is a single defect pixel, the R pixels 511 to 514, which are surrounding same-color pixels, are extracted as candidate interpolated pixels. In this case, the R pixels 512 and 514 in the horizontal direction are selected as interpolated pixels from among the extracted four pixels, for example. Then, an average value of the selected R pixels 512 and 514 is calculated. Then, the value of the defective pixel 510 is substituted with the calculated average value of the R pixels 512 and 514. Alternatively, the R pixels 511 and 513 in the vertical direction may be selected as interpolated pixels from among the extracted four pixels and the value of the defective pixel 510 may be substituted with the calculated average value of the R pixels 511 and 513.

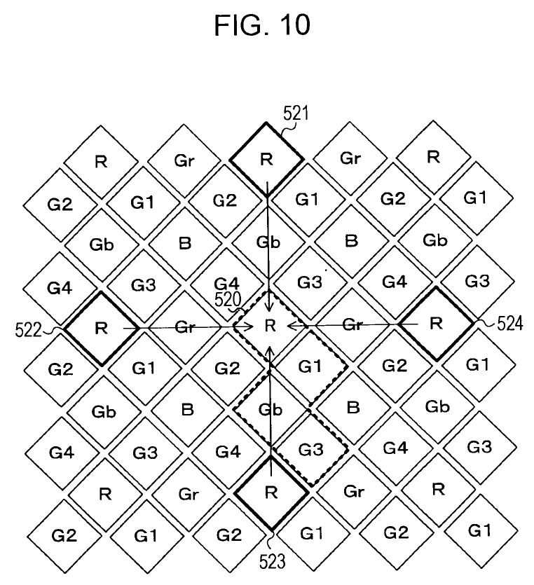

FIG. 10 schematically illustrates an example of a pixel array in a case where an R pixel is a defective pixel and a pixel group including the R pixel has a pixel sharing defect.

In the pixel array illustrated in FIG. 10, a pixel group 520 including the R pixel has a pixel sharing defect, but R pixels 521 to 524, which are same-color pixels physically next to the adjacent pixels of the R pixel included in the pixel group 520 in the horizontal and vertical directions, are not defective pixels. In this case, even if the pixel group 520 including the R pixel has a pixel sharing defect, the R pixels 521 to 524 as surrounding same-color pixels are not affected, and thus the R pixels 521 to 524 are extracted as candidate interpolated pixels, as in the case of the single defective pixel. The selection of interpolated pixels, calculation of an average value, and the substituting process are the same as those in the case of the single defective pixel, and thus the corresponding description is omitted. The R pixel is used as an example in FIGS. 9 and 10, but the above description is also applied to the B pixel, and thus the corresponding description is omitted.

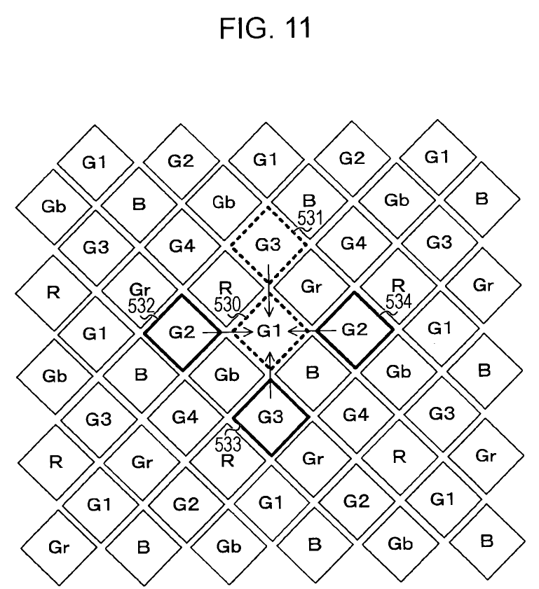

FIG. 11 schematically illustrates an example of a pixel array in a case where a G1 pixel is a defective pixel and a defective pixel exists in the adjacent pixels of the G1 pixel in the vertical direction.

In the pixel array illustrated in FIG. 11, a G1 pixel 530 is a defective pixel, and a G3 pixel 531 adjacent to the G1 pixel 530 in the vertical direction is also a defective pixel. As in this case, when the G1 pixel 530 is a defective pixel, a G3 pixel 531, a G2 pixel 532, a G3 pixel 533, and a G2 pixel 534, which are same-color pixels adjacent to the G1 pixel 530 in the horizontal and vertical directions, are extracted as candidate surrounding pixels to be interpolated.

Among the extracted four pixels, the G3 pixel 531 is a defective pixel but the G2 pixel 532 and the G2 pixel 534 in the horizontal direction are not defective pixels. In this case, the G2 pixel 532 and the G2 pixel 534 in the horizontal direction are selected as interpolated pixels from among the extracted four pixels. Then, an average value of the selected G2 pixel 532 and G2 pixel 534 is calculated. Then, the value of the defective pixel 530 is substituted with the calculated average value of the G2 pixel 532 and the G2 pixel 534. In this way, even when the G1 pixel is a defective pixel and when any of the same-color pixels adjacent to the G1 pixel in the horizontal and vertical directions is a defective pixel, an average value can be calculated by using two pixels in any of the horizontal and vertical directions.

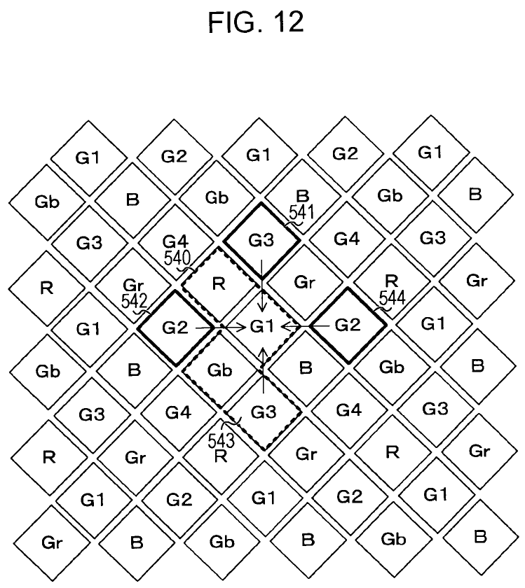

FIG. 12 schematically illustrates an example of a pixel array in a case where a pixel group 540 including a G1 pixel has a pixel sharing defect.

In the pixel array illustrated in FIG. 12, the pixel group 540 including the G1 pixel has a pixel sharing defect. Also, among the same-color pixels physically adjacent to the G1 pixel included in the pixel group 540 in the horizontal and vertical directions, a G3 pixel 541, a G2 pixel 542, and a G2 pixel 544 are not defective pixels, and a G3 pixel 543 included in the pixel group 540 is a defective pixel. As in this case, when the pixel group 540 including the G1 pixel has a pixel sharing defect, the G3 pixel 543 as an adjacent same-color pixel is a defective pixel. Thus, as in the case of the single defective pixel, the G3 pixel 541, the G2 pixel 542, the G3 pixel 543, and the G2 pixel 544 are extracted as candidate interpolated pixels, but the G2 pixel 542 and the G2 pixel 544 in the horizontal direction are selected as interpolated pixels from among the extracted four pixels because the G3 pixel 543 is a defective pixel. The calculation of an average value and the substituting process are the same as those in the above-described case of the single defective pixel. Thus, the corresponding description is omitted. In this way, when the pixel group including the G1 pixel has a pixel sharing defect and when the same-color pixels adjacent to the G1 pixel other than the G3 pixel are not defective pixels, interpolated pixels can be selected without being directly affected by the pixel sharing defect.

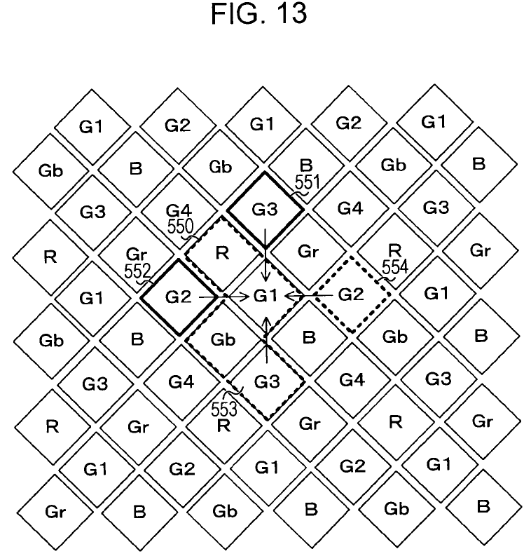

FIG. 13 schematically illustrates an example of a pixel array in a case where a pixel group including a G1 pixel has a pixel sharing defect and a defective pixel exists in the pixels adjacent to the G1 pixel in the horizontal direction.

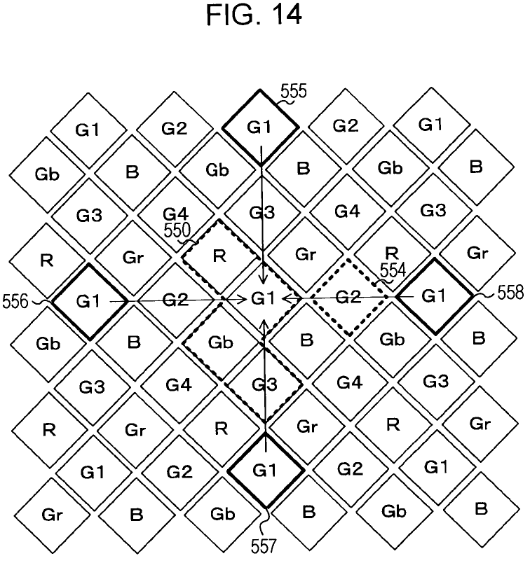

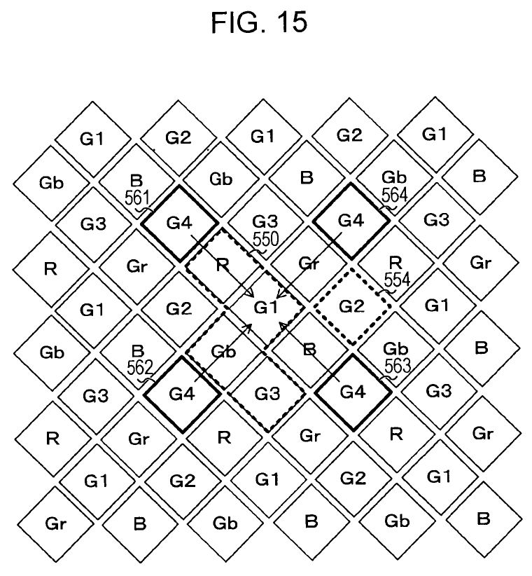

In the pixel array illustrated in FIG. 13, a pixel group 550 including a G1 pixel has a pixel sharing defect. Also, among the same-color pixels physically adjacent to the G1 pixel included in the pixel group 550 in the horizontal and vertical directions, a G3 pixel 551 and a G2 pixel 552 are not defective pixels, but a G2 pixel 554 and a G3 pixel 553 (included in the pixel group 550) are defective pixels. As in this case, when the pixel group 550 including the G1 pixel has a pixel sharing defect and when the G2 pixel 554 adjacent to the G1 pixel is a defective pixel, if an average value is calculated by using the G3 pixel 551 and the G3 pixel 553 or the G2 pixel 552 and the G2 pixel 554, which are same-color pixels adjacent to the G1 pixel in the vertical or horizontal direction, then a defective pixel is used in the calculation. In such a case, an average value can be calculated by using same-color pixels physically next to the adjacent pixels of the G1 pixel included in the pixel group 550 in the horizontal and vertical directions or diagonal directions, as illustrated in FIG. 14 or 15.

FIG. 14 schematically illustrates an example of a pixel array in the same case as that illustrated in FIG. 13.

As described above with reference to FIG. 13, if an average value is calculated by using the same-color pixels adjacent to the G1 pixel included in the pixel group 550 in the horizontal and vertical directions, then it means calculation using a defective pixel. In such a case, as illustrated in FIG. 14, an average value is calculated by using G1 pixels 555 to 558, which are same-color pixels physically next to the adjacent pixels of the G1 pixel included in the pixel group 550 in the horizontal and vertical directions. That is, the G1 pixels 555 to 558 as surrounding same-color pixels are extracted as candidate interpolated pixels. In this case, the G1 pixels 556 and 558 in the horizontal direction are selected as interpolated pixels from among the extracted four pixels, and an average value of the selected G1 pixels 556 and 558 is calculated. The calculation of the average value and the substituting process are the same as those in the case of the single defective pixel, and thus the corresponding description is omitted. Alternatively, the G1 pixels 555 and 557 in the vertical direction may be selected as interpolated pixels from among the extracted four pixels, and the value of the defective pixel may be substituted with an average value of the G1 pixels 555 and 557.

FIG. 15 schematically illustrates an example of a pixel array in the same case as that illustrated in FIG. 13.

In this case, as illustrated in FIG. 15, an average value is calculated by using G4 pixels 561 to 564, which are same-color pixels physically next to the adjacent pixels of the G1 pixel included in the pixel group 550 in the diagonal directions. That is, the G4 pixels 561 to 564 as surrounding same-color pixels are extracted as candidate interpolated pixels. In this case, the G4 pixels 561 and 563 in the descending direction are selected as interpolated pixels from among the extracted four pixels, and an average value of the selected G4 pixels 561 and 563 is calculated. The calculation of the average value and the substituting process are the same as those in the case of the single defective pixel, and thus the corresponding description is omitted. Alternatively, the G4 pixels 562 and 564 in the ascending direction may be selected as interpolated pixels from among the extracted four pixels, and the value of the defective pixel may be substituted with an average value of the G4 pixels 562 and 564. In FIGS. 11 to 15, the G1 pixel is used as an example, but the above description can also be applied to the G2 to G4 pixels. The corresponding description is omitted.

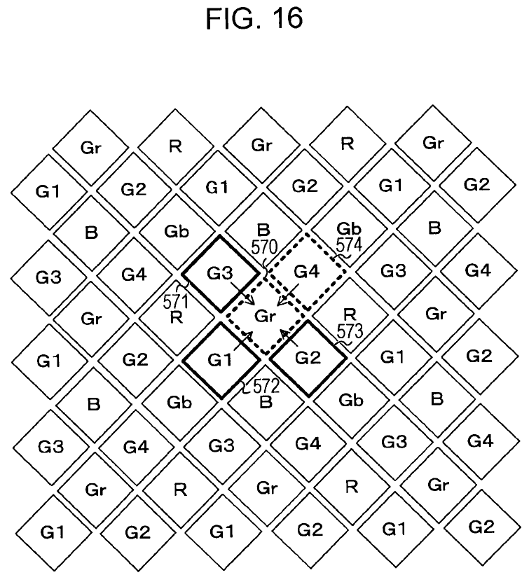

FIG. 16 schematically illustrates an example of a pixel array in a case where a Gr pixel is a defective pixel and a defective pixel exist in the pixels adjacent to the Gr pixel in diagonal directions.

In the pixel array illustrated in FIG. 16, a Gr pixel 570 is a defective pixel, and a G4 pixel 574 adjacent to the Gr pixel 570 in the ascending direction is also a defective pixel. As in this case, when the Gr pixel 570 is a defective pixel, a G3 pixel 571, a G1 pixel 572, a G2 pixel 573, and the G4 pixel 574, which are same-color pixels adjacent in the diagonal directions, are extracted as surrounding candidate pixels to be interpolated.

However, the G4 pixel 574 among the extracted four pixels is a defective pixel. In this case, the G3 pixel 571 and the G2 pixel 573, which are same-color pixels in the descending direction, are selected as candidate interpolated pixels from among the extracted four pixels. Then, an average value of the selected G3 pixel 571 and the G2 pixel 573 is calculated. Then, the value of the defective pixel 570 is substituted with the calculated average value of the G3 pixel 571 and the G2 pixel 573.

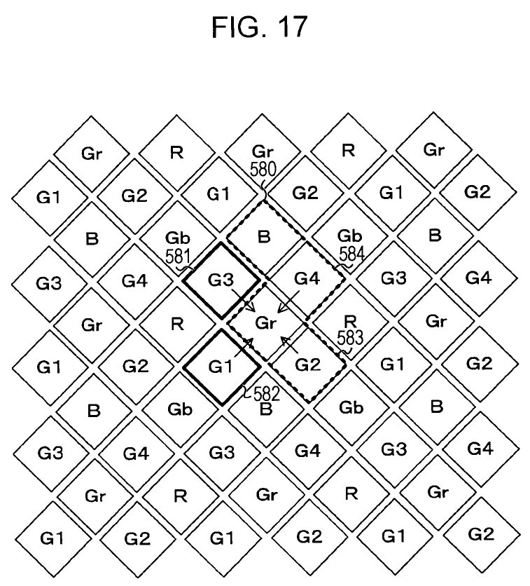

FIG. 17 schematically illustrates an example of a pixel array in a case where a pixel group including a Gr pixel has a pixel sharing defect.

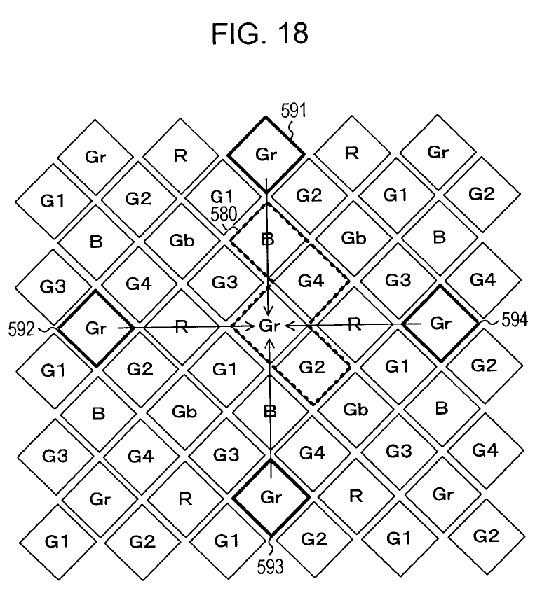

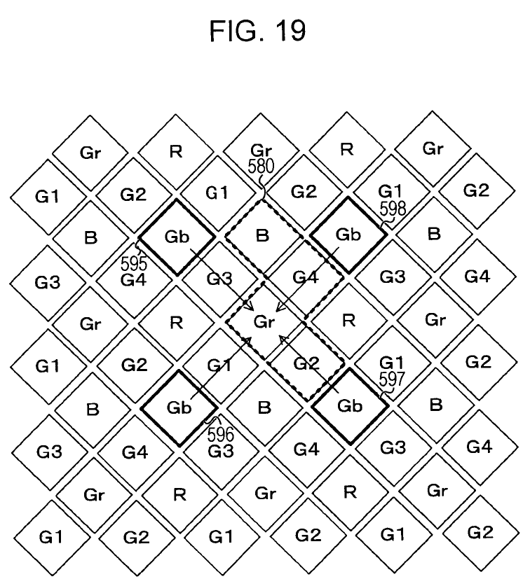

In the pixel array illustrated in FIG. 17, a pixel group 580 including a Gr pixel has a pixel sharing defect, and a G3 pixel 581 and a G1 pixel 582, which are same-color pixels physically adjacent to the Gr pixel included in the pixel group 580 in the diagonal directions, are not defective pixels. As in this case, when the pixel group 580 including the Gr pixel has a pixel sharing defect, if an average value is calculated by using the G3 pixel 581 and the G2 pixel 583 or the G1 pixel 582 and the G4 pixel 584, which are same-color pixels adjacent to the Gr pixel in the diagonal direction, then a defective pixel is used in the calculation. In such a case, an average value can be calculated by using same-color pixels physically next to the adjacent pixels of the Gr pixel included in the pixel group 580 in the horizontal and vertical directions or the diagonal directions, as illustrated in FIG. 18 or 19.

FIG. 18 schematically illustrates an example of a pixel array in the same case as that illustrated in FIG. 17.

As described above with reference to FIG. 17, if an average value is calculated by using the same-color pixels adjacent to the Gr pixel included in the pixel group 580 in the diagonal directions, then it means calculation using a defective pixel. In such a case, as illustrated in FIG. 18, an average value is calculated by using Gr pixels 591 to 594, which are same-color pixels physically next to the adjacent pixels of the Gr pixel included in the pixel group 580 in the horizontal and vertical directions. That is, the Gr pixels 591 to 594 as surrounding same-color pixels are extracted as candidate interpolated pixels. In this case, the Gr pixels 592 and 594 in the horizontal direction are selected as interpolated pixels from among the extracted four pixels, and an average value of the selected Gr pixels 592 and 594 is calculated. The calculation of the average value and the substituting process are the same as those in the case of the single defective pixel, and thus the corresponding description is omitted. Alternatively, the Gr pixels 591 and 593 in the vertical direction may be selected as interpolated pixels from among the extracted four pixels, and the value of the defective pixel may be substituted with an average value of the Gr pixels 591 and 593.

FIG. 19 schematically illustrates an example of a pixel array in the same case as that illustrated in FIG. 17.

In this case, as illustrated in FIG. 19, an average value is calculated by using Gb pixels 595 to 598, which are same-color pixels physically next to the adjacent pixels of the Gr pixel included in the pixel group 580 in the diagonal directions. That is, the Gb pixels 595 to 598 as surrounding same-color pixels are extracted as candidate interpolated pixels. In this case, the Gb pixels 595 and 597 in the descending direction are selected as interpolated pixels from among the extracted four pixels, and an average value of the selected Gb pixels 595 and 597 is calculated. The calculation of the average value and the substituting process are the same as those in the case of the single defective pixel, and thus the corresponding description is omitted. Alternatively, the Gb pixels 596 and 598 in the ascending direction may be selected as interpolated pixels from among the extracted four pixels, and the value of the defective pixel may be substituted with an average value of the Gb pixels 596 and 598. In FIGS. 16 to 19, the Gr pixel is used as an example, but the above description can also be applied to the Gr pixel. The corresponding description is omitted.

As described above with reference to FIGS. 9 to 19, by correcting a defective pixel by selecting surrounding pixels in a diagonal pixel array, degradation of quality of a captured image by correction can be suppressed.

Hereinafter, an operation of the imaging apparatus 100 according to the embodiment of the present invention is described with reference to the drawings.

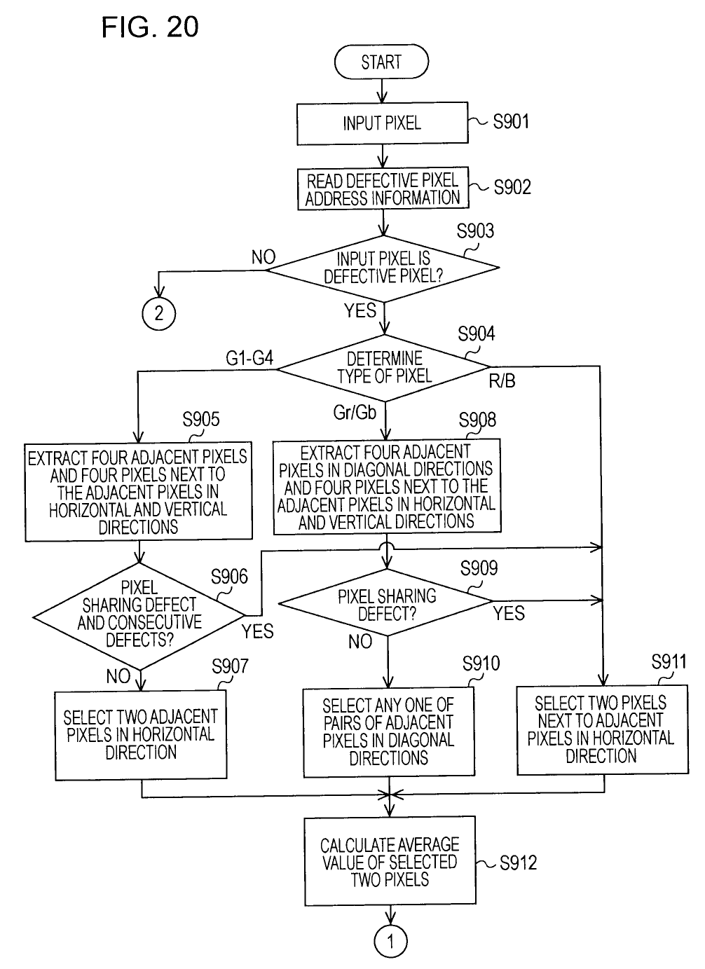

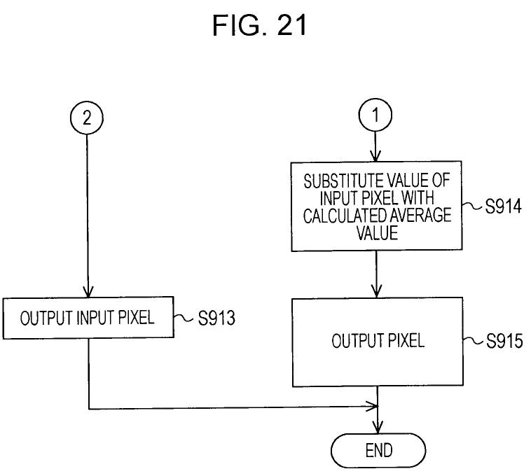

FIGS. 20 and 21 are flowcharts illustrating a procedure of a process of correcting a defective pixel, performed by the imaging apparatus 100. In the example described below, it is determined whether one of adjacent pixels in the horizontal direction of a defective pixel to be corrected is a defective pixel (consecutive adjacent pixels), and interpolated pixels are selected based on the determination result. If any of the surrounding same-color pixels in the horizontal and vertical directions of the defective pixel to be corrected is not a defective pixel, the same-color pixels in the horizontal direction are selected. Furthermore, if any of the surrounding same-color pixels in the diagonal directions of the defective pixel to be corrected is not a defective pixel, the same-color pixels in the descending direction are selected. The selecting condition can be changed through a user operation.

First, a pixel is input (step S901). Then, defective pixel address information is read from the defective pixel address storing unit 320 (step S902). Then, the defective pixel determining unit 330 compares a counter value input from the counter generator 310 with the defective pixel address information read from the defective pixel address storing unit 320, and determines whether the target pixel is a defective pixel (step S903). The comparing process is performed by the defect determining unit 331 and the pixel sharing defect determining unit 333. If it is determined that the target pixel is not a defective pixel as a result of the comparing process (step S903), the target pixel is output without being corrected (step S913), and the defective pixel correcting process ends.

On the other hand, if it is determined that the target pixel is a defective pixel as a result of the comparing process (step S903), the type of the target pixel is determined (step S904). If the type of the target pixel is any of the G1 to G4 pixels (step S904), four same-color pixels physically adjacent to the defective pixel in the horizontal and vertical directions and four same-color pixels physically next to the adjacent pixels of the defective pixel are extracted (step S905). Then, it is determined whether the input defective pixel has a pixel sharing defect and whether any of the pixels adjacent to the input defective pixel is a defective pixel (step S906). If the input defective pixel has a pixel sharing defect and if any of the pixels adjacent to the input defective pixel is a defective pixel (step S906), the process proceeds to step S911.

On the other hand, if the input defective pixel does not have a pixel sharing defect or if any of the pixels adjacent to the input defective pixel is not a defective pixel (step S906), two pixels adjacent to the input defective pixel in the horizontal direction are selected as interpolated pixels from among the extracted surrounding pixels (step S907).

If it is determined that the type of the target pixel is the Gr pixel or the Gb pixel (step S904), four same-color pixels physically adjacent to the defective pixel in the diagonal directions and four same-color pixels physically next to the adjacent pixels of the defective pixel in the horizontal and vertical directions are extracted (step S908). Then, it is determined whether the input defective pixel has a pixel sharing defect (step S909). If the input defective pixel has a pixel sharing defect (step S909), the process proceeds to step S911.

On the other hand, if the input defective pixel does not have a pixel sharing defect (step S909), the two pixels in the descending direction are selected as interpolated pixels from among the four pixels adjacent to the input defective pixel in the diagonal directions among the extracted surrounding pixels (step S910).

If it is determined that the type of the target pixel is the R pixel or the B pixel (step S904), the two same-color pixels physically next to the adjacent pixels of the input defective pixel in the horizontal direction are selected as interpolated pixels (step S911).

Then, an average value of the selected two pixels is calculated (step S912). Then, the value of the input defective pixel is substituted with the calculated average value (step S914), and the pixel on which the substituting process has been done is output (step S915).

Alternatively, if the input defective pixel does not have a pixel sharing defect or if any of the pixels adjacent to the input defective pixel is not a defective pixel (step S906), a correlation value determining process may be performed on the four same-color pixels physically adjacent to the defective pixel among the surrounding pixels extracted in step S905, and an average value determined to have a strong correlation may be selected as an interpolation value of the defective pixel. More specifically, in the four same-color pixels physically adjacent to the defective pixel extracted in step S905, an average value and a differential absolute value (correlation value) of the two pixels in the horizontal direction and an average value and a differential absolute value (correlation value) of the two pixels in the vertical direction are calculated, and it is determined that the smaller one of the two calculated differential absolute values has a stronger correlation. Then, the average value of the two pixels in the direction corresponding to the value of the stronger correlation is selected as an interpolation value of the defective pixel. Also, in a case where the type of the input pixel is determined to be the Gr pixel, the Gb pixel, the R pixel, or the B pixel in step S904, the correlation value determining process may be performed and an average value having a stronger correlation may be selected as an interpolation value of the defective pixel.

In a case where the type of the target pixel is any of the G1 to G4 pixels, the target pixel has a pixel sharing defect, and any of the pixels adjacent to the target pixel is a defective pixel (step S906), two pixels in any of the diagonal directions may be selected as interpolated pixels from among the same-color pixels physically next to the adjacent pixels of the target pixel in step S911.

Furthermore, in a case where the type of the target pixel is the Gr pixel or the Gb pixel and the target pixel has a pixel sharing defect (step S906), two pixels in any of the diagonal directions may be selected as interpolated pixels from among the same-color pixels physically next to the adjacent pixels of the target pixel. Such selection may be set in advance.

In the above-described embodiment of the present invention, a consecutive defect flag about adjacent pixels in the horizontal direction is generated by the consecutive defect determining unit 335. Alternatively, a consecutive defect flag about a consecutive adjacent pixel defect in the horizontal direction may be generated by using a delay element, such as a D-FF. Also, a consecutive defect flag about a consecutive adjacent pixel defect in the vertical direction can be generated by performing a process of calculating addresses of adjacent pixels in the vertical direction, a process of scanning and reading defective pixel address information of the adjacent pixels in the vertical direction from the defective pixel address storing unit 320, and a process of comparing the calculated addresses of the adjacent pixels in the vertical direction with the read defective pixel address information of the adjacent pixels in the vertical direction.

In the above-described embodiment of the present invention, a single imaging device is used as the imaging device 160. Alternatively, the embodiment of the present invention can be applied to an imaging apparatus including three imaging devices. When interpolated pixels are selected in this imaging apparatus, pixels that are approximate in a spatial phase are selected.

In the above-described embodiment of the present invention, the defective pixel address information of only the head pixel in a pixel group having the pixel sharing structure is stored in the defective pixel address storing unit 320. Alternatively, the defective pixel address information of each pixel in the pixel group having the pixel sharing structure may be stored in the defective pixel address storing unit 320.

In the above-described embodiment of the present invention, an example of the pixel sharing defect resulting from the pixel sharing structure is described as an adjacent pixel defect of a plurality of pixels. Alternatively, the embodiment of the present invention can be applied to an adjacent pixel defect resulting from another factor.

In the above-described embodiment of the present invention, the correction distance switching flag 410 indicates whether a defective pixel has a pixel sharing defect. However, the correction distance switching flag 410 can be arbitrarily set when being stored in the defective pixel address storing unit 320, and thus can be used an indicator for selecting interpolated pixels for an arbitrary defective pixel other than the pixel sharing defect.

In the above-described embodiment of the present invention, an example of the pixel sharing structure to share part of a transistor group constituting pixels of an imaging device in units of four pixels in a color filter having a diagonal pixel array has been described. Alternatively, the embodiment of the present invention can be applied to another number of sharing pixels and another sharing pattern.

In the above-described embodiment of the present invention, a single imaging device using a color filter having a diagonal pixel array has been described. Alternatively, the embodiment of the present invention can be applied to an imaging device using a color filter having another type of pixel array.

As described above, according to the embodiment of the present invention, the candidate interpolated pixel selector 340 selects interpolated pixels for a defective pixel by using the defective pixel address information 400 including the correction distance switching flag 410, so that an adjacent pixel defect resulting from the pixel sharing structure can be appropriately corrected. That is, for an adjacent pixel defect in which a plurality of adjacent pixels have a defect, an interpolation value is not calculated by using a defective pixel adjacent to the target defective pixel. Thus, correction can be made by using an appropriate interpolation value, and degradation of quality of a corrected image can be suppressed. Also, consecutive adjacent defective pixels can be appropriately corrected, and each defective pixel included in a defective pixel group constituted by a plurality of defective pixels can be appropriately corrected.

The interpolation value calculator 350 can be used for all the types of pixel defect, such as a single pixel defect, a consecutive adjacent pixel defect, and a pixel sharing defect. Thus, the size, weight, and cost of the imaging apparatus can be reduced.

Furthermore, by providing the adjacent pixel address calculator 332 in the defective pixel determining unit 330 and by storing defective pixel address information of only the head defective pixel having the pixel sharing structure in the defective pixel address storing unit 320, the resources of the register or the memory used as the defective pixel address storing unit 320 can be reduced. Furthermore, the size, weight, and cost of the imaging apparatus can be reduced.

As interpolated pixels used for calculating an interpolation value, interpolated pixels are selected from among a plurality of candidate interpolated pixels in accordance with the type of pixel. Thus, the embodiment of the present invention can also be applied to an imaging device using a color filter having a pixel array other than the diagonal pixel array, and a process of correcting a defective pixel can be flexibly performed independently from the type of pixel array of the color filter.

Furthermore, the embodiment of the present invention can be realized by hardware of a simple configuration. Thus, a real-time process can be performed even in a recent trend of many pixels. Also, an appropriate defect correcting process can be performed even in a high-rate imaging function that performs imaging at a higher rate than a normal imaging rate.

The above-described embodiment of the present invention is only an example to embody the present invention, and the elements described in the embodiment have a correspondence with the specific feature of the claims, as described below. However, the present invention is not limited to the embodiment, and various modifications can be carried out without deviating from the scope of the present invention.

The imaging apparatus in the claims corresponds to the imaging apparatus 100, for example. The defective pixel correcting apparatus in the claims corresponds to the defective pixel corrector 300, for example.

The defective pixel storing means in the claims corresponds to the defective pixel address storing unit 320, for example. The defective pixel determining means corresponds to the defect determining unit 331, for example. The pixel sharing defect determining means corresponds to the pixel sharing defect determining unit 333, for example.

The image input means in the claims corresponds to the line buffer 307, for example. The pixel type determining means corresponds to the pixel type determining unit 341, for example. The interpolation value calculating means corresponds to the interpolation value calculator 350, for example. The interpolation value substituting means corresponds to the interpolation value substituting unit 360, for example.

The interpolated pixel selecting means in the claims corresponds to the interpolated pixel selector 343, for example.

The positional information calculating means in the claims corresponds to the adjacent pixel address calculator 332, for example.

The consecutive defect determining means in the claims corresponds to the pixel sharing defect determining unit 333, for example.

The inputting an image in the claims corresponds to step S901, for example. The determining whether each pixel is a defective pixel corresponds to step S903, for example. The determining whether the pixel determines to be a defective pixel is included in the defective pixel group corresponds to step S906 or S909, for example. The determining the type of each pixel corresponds to step S904, for example. The selecting surrounding pixels corresponds to step S907, S910, or S911, for example. The calculating an interpolation value corresponds to step S912, for example. The substituting the value corresponds to step S914, for example.

The processing procedure described in the embodiment of the present invention can be regarded as a method including a series of those steps, or as a program allowing a computer to execute the series of steps, or a recording medium storing the program.

What is claimed is:

1. An imaging apparatus comprising:
defective pixel storing means for storing positional information of a defective pixel among pixels included in an imaging device and pixel defect information indicating whether a defective pixel group including a plurality of defective pixels includes the defective pixel related to the positional information, the positional information being associated with the pixel defect information;
image input means for inputting an image captured by the imaging device;
defective pixel determining means for determining whether each pixel in the input image is a defective pixel based on the positional information stored in the defective pixel storing means;
pixel sharing defect determining means for determining whether the pixel determined to be a defective pixel is included in the defective pixel group based on the pixel defect information stored in the defective pixel storing means;
pixel type determining means for determining the type of each pixel in the input image;
interpolated pixel selecting means for selecting surrounding pixels of the pixel determined to be a defective pixel based on the type of the defective pixel and a determination result indicating whether the defective pixel is included in the defective pixel group;
interpolation value calculating means for calculating an interpolation value of the pixel determined to be a defective pixel based on values of the selected surrounding pixels; and
interpolation value substituting means for substituting the value of the pixel determined to be a defective pixel with the calculated interpolation value.

2. The imaging apparatus according to claim 1,
wherein the defective pixel storing means stores the positional information and the pixel defect information of one of the defective pixels included in the defective pixel group,
the imaging apparatus further comprising positional information calculating means for calculating positional information of the other defective pixels in the defective pixel group including the defective pixel based on the positional information of the one of the defective pixels included in the defective pixel group stored in the defective pixel storing means,
wherein the defective pixel determining means determines whether each pixel in the input image is a defective pixel based on the positional information stored in the defective pixel storing means and the calculated positional information, and
wherein the pixel sharing defect determining means determines whether the pixel determined to be a defective pixel is included in the defective pixel group based on the calculated positional information.

3. The imagine apparatus according to claim 1,
wherein the defective pixel group is a pixel group including a plurality of adjacent defective pixels.

4. The imaging apparatus according to claim 1,
wherein the imagine device includes a pixel group having a pixel sharing structure, and
wherein the defective pixel group is a pixel group in which a plurality of pixels included in the pixel group having the pixel sharing structure have a defect.

5. The imaging apparatus according to claim 4,
wherein a color filter having a diagonal pixel array is attached to a light receiving unit of the imaging device, and
wherein the pixel group having the pixel sharing structure includes four adjacent pixels in the diagonal pixel array.

6. The imaging apparatus according to claim 1, further comprising:
consecutive defect determining means for determining whether an adjacent pixel of the pixel determined to be a defective pixel is a defective pixel based on the positional information of the pixel determined to be a defective pixel,
wherein the interpolated pixel selecting means selects surrounding pixels of the pixel determined to be a defective pixel based on the type of the defective pixel, a determination result indicating whether the defective pixel is included in the defective pixel group, and a determination result indicating whether the adjacent pixel of the pixel determined to be a defective pixel is a defective pixel.

7. A defective pixel correcting apparatus comprising:
defective pixel storing means for storing positional information of a defective pixel among pixels included in an imaging device and pixel defect information indicating whether a defective pixel group including a plurality of defective pixels includes the defective pixel related to the positional information, the positional information being associated with the pixel defect information;
image input means for inputting an image captured by the imaging device;
defective pixel determining means for determining whether each pixel in the input image is a defective pixel based on the positional information stored in the defective pixel storing means;
pixel sharing defect determining means for determining whether the pixel determined to be a defective pixel is included in the defective pixel group based on the pixel defect information stored in the defective pixel storing means;
pixel type determining means for determining the type of each pixel in the input image;
interpolated pixel selecting means for selecting surrounding pixels of the pixel determined to be a defective pixel based on the type of the defective pixel and a determination result indicating whether the defective pixel is included in the defective pixel group;
interpolation value calculating means for calculating an interpolation value of the pixel determined to be a defective pixel based on values of the selected surrounding pixels; and
interpolation value substituting means for substituting the value of the pixel determined to be a defective pixel with the calculated interpolation value.

8. A defective pixel correcting method in an imaging apparatus including defective pixel storing means for storing positional information of a defective pixel among pixels included in an imaging device and pixel defect information indicating whether a defective pixel group including a plurality of defective pixels includes the defective pixel related to the positional information, the positional information being associated with the pixel defect information, the defective pixel correcting method comprising the steps of:
inputting an image captured by the imaging device;
determining whether each pixel in the input image is a defective pixel based on the positional information stored in the defective pixel storing means;
determining whether the pixel determined to be a defective pixel is included in the defective pixel group based on the pixel defect information stored in the defective pixel storing means;
determining the type of each pixel in the input image;
selecting surrounding pixels of the pixel determined to be a defective pixel based on the type of the defective pixel and a determination result indicating whether the defective pixel is included in the defective pixel group;
calculating an interpolation value of the pixel determined to be a defective pixel based on values of the selected surrounding pixels; and
substituting the value of the pixel determined to be a defective pixel with the calculated interpolation value.

9. A program allowing a computer to execute the steps of, in an imaging apparatus including defective pixel storing means for storing positional information of a defective pixel among pixels included in an imaging device and pixel defect information indicating whether a defective pixel group including a plurality of defective pixels includes the defective pixel related to the positional information, the positional information being associated with the pixel defect information:
inputting an image captured by the imaging device;
determining whether each pixel in the input image is a defective pixel based on the positional information stored in the defective pixel storing means;
determining whether the pixel determined to be a defective pixel is included in the defective pixel group based on the pixel defect information stored in the defective pixel storing means;
determining the type of each pixel in the input image;
selecting surrounding pixels of the pixel determined to be a defective pixel based on the type of the defective pixel and a determination result indicating whether the defective pixel is included in the defective pixel group;
calculating an interpolation value of the pixel determined to be a defective pixel based on values of the selected surrounding pixels; and
substituting the value of the pixel determined to be a defective pixel with the calculated interpolation value.

10. An imaging apparatus comprising:
a defective pixel storing unit configured to store positional information of a defective pixel among pixels included in an imaging device and pixel defect information indicating whether a defective pixel group including a plurality of defective pixels includes the defective pixel related to the positional information, the positional information being associated with the pixel defect information;
an image input unit configured to input an image captured by the imaging device;
a defective pixel determining unit configured to determine whether each pixel in the input image is a defective pixel based on the positional information stored in the defective pixel storing unit;
a pixel sharing defect determining unit configured to determine whether the pixel determined to be a defective pixel is included in the defective pixel group based on the pixel defect information stored in the defective pixel storing unit;
a pixel type determining unit configured to determine the type of each pixel in the input image;
an interpolated pixel selecting unit configured to select surrounding pixels of the pixel determined to be a defective pixel based on the type of the defective pixel and a determination result indicating whether the defective pixel is included in the defective pixel group;
an interpolation value calculating unit configured to calculate an interpolation value of the pixel determined to be a defective pixel based on values of the selected surrounding pixels; and
an interpolation value substituting unit configured to substitute the value of the pixel determined to be a defective pixel with the calculated interpolation value.

11. A defective pixel correcting apparatus comprising:
a defective pixel storing unit configured to store positional information of a defective pixel among pixels included in an imaging device and pixel defect information indicating whether a defective pixel group including a plurality of defective pixels includes the defective pixel related to the positional information, the positional information being associated with the pixel defect information;
an image input unit configured to input an image captured by the imaging device;
a defective pixel determining unit configured to determine whether each pixel in the input image is a defective pixel based on the positional information stored in the defective pixel storing unit;
a pixel sharing defect determining unit configured to determine whether the pixel determined to be a defective pixel is included in the defective pixel group based on the pixel defect information stored in the defective pixel storing unit;
a pixel type determining unit configured to determine the type of each pixel in the input image;
an interpolated pixel selecting unit configured to select surrounding pixels of the pixel determined to be a defective pixel based on the type of the defective pixel and a determination result indicating whether the defective pixel is included in the defective pixel group;
an interpolation value calculating unit configured to calculate an interpolation value of the pixel determined to be a defective pixel based on values of the selected surrounding pixels; and
an interpolation value substituting unit configured to substitute the value of the pixel determined to be a defective pixel with the calculated interpolation value.
